(19) United States
(12) Patent Application Publication
(10) Pub. No.: US 2010/0183892 A1
(43) Pub. Date: Jul. 22, 2010

(54) CATHODE CORROSION PROTECTION FOR REINFORCEMENTS OF REINFORCED CONCRETE STRUCTURES

(75) Inventors: Heinz Bänziger, Freienstein (CH); Norman Blank, Ruschlikon (CH); Jörg Vogelsang, Widen (CH); Georg Schulze, Stuttgart (DE)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/451,276

(22) PCT Filed: Jul. 10, 2008
(86) PCT No.: PCT/EP2008/058969

§ 371 Date: Mar. 8, 2010

(30) Foreign Application Priority Data
Jul. 10, 2007 (EP) 07112178.4

(51) Int. Cl. B32B 15/092; B05D 3/02; B05D 5/00

(52) U.S. Cl. 428/551; 427/386; 427/287

(57) ABSTRACT

The use of a composition Z comprising at least one epoxy resin A, at least one curing agent B for epoxy resins and also zinc particles as cathode corrosion protection for reinforcements of reinforced concrete structures. The composition is here applied to the reinforcing steel at certain points and is suitable as corrosion protection for reinforcements of reinforced concrete structures both when erecting and repairing such a structure.

### FIELD OF THE INVENTION

The invention relates to the field of cathodic corrosion protection for reinforcements of reinforced concrete structures.

### PRIOR ART

The use of zinc particles, in particular of zinc dust, or of alloys of zinc as a corrosion protection pigment in primer coating materials based on epoxy resins is widespread in cathodic corrosion protection. Such compositions are present in one-component or two-component form and are suitable in particular as a corrosion protection paint for steel surfaces. They are described, for example in EP 0 385 880 A2 or in EP 0 560 785 B1. Such systems are not suitable for the cathodic corrosion protection of reinforcements of reinforced concrete structures since they have to be applied as a coating over the whole area. This is not possible in particular in the repair of reinforced concrete structures, where the reinforcing steel is not completely exposed but only at certain points.

Various systems based on zinc and zinc alloys are known and are commercially available for the cathodic corrosion protection of reinforcing steel. These are described, for example in U.S. Pat. No. 6,193,857 and in WO 2005/121760 A1. These systems consist of a prefabricated anode which is provided with wires by means of which the anode is fastened to the reinforcing steel and which at the same time produce the necessary contact of the reinforcing steel with the zinc. Such systems for cathodic corrosion protection have the disadvantage that their mounting on the reinforcing steel is very complicated. This is the case in particular when the anodes are to be mounted during repairs of reinforced concrete structures. Reinforcing steel must in fact be exposed all round at the point where the anode is to be placed, since otherwise the wires cannot be fastened to the steel. In the case of reinforcements not yet embedded in concrete, the considerable time requirement for the mounting of such corrosion protection systems is in particular disadvantageous. Furthermore, it has been found to be a disadvantage that the anodes which are fastened with wires to the reinforcing steel have only a very small contact area between the steel and the zinc, and the corrosion protection performance is adversely affected thereby.

### SUMMARY OF THE INVENTION

The object of the present invention is therefore to provide a process for cathodic corrosion protection which overcomes the disadvantages of the prior art and, owing to its versatile and simple applicability, offers optimum corrosion protection.

According to the invention, this is achieved by the features of the first claim. Surprisingly, epoxy resin compositions which have a high proportion of zinc particles as a filler have proven to be particularly suitable systems for the cathodic corrosion protection of reinforcing steel.

The advantages of the invention are, inter alia, that the use according to the invention of such compositions for the cathodic corrosion protection of reinforcing steel has proven to be very simple and time-saving and functions optimally even under unfavorable space conditions, for example in repair of reinforced concrete structures. Furthermore, it is advantageous that the composition used adheres both to the reinforcing steel and to concrete and mortar and, even after repair, thus forms a non-positively bonded structure which has no weak points in the region of the corrosion protection system. The improved corrosion protection performance compared with the prior art has likewise proven to be of particular advantage and is due in particular to the larger contact area of the corrosion protection system according to the invention with the reinforcing steel.

Further aspects of the invention form the subject of further independent claims. Particularly preferred embodiments of the invention form the subject of the dependent claims.

The present invention relates to the use of a composition Z, comprising at least one epoxy resin A, at least one curing agent B for epoxy resins and zinc particles, as cathodic corrosion protection for reinforcements of reinforced concrete structures.

In the present document, the term “reinforcement” is understood as meaning the incorporation of steel into a building material for reinforcement. This steel is referred to as “reinforcing steel” and may be arranged, for example, in the form of steel mats, steel rods or a net of steel rods. Mainly, reinforcements are used in concrete construction, concrete reinforced with reinforcing steel being referred to as “reinforced concrete”. Any construction comprising reinforced concrete is referred to as “reinforced concrete structure”.

The epoxy resin A, which has on average more than one epoxide group per molecule, is preferably a liquid epoxy resin or a solid epoxy resin.

The term “solid epoxy resin” is very well known to the person skilled in the art in the area of epoxides and is used in contrast to “liquid epoxy resin”. The glass transition temperature of solid resins is above room temperature, i.e. they can be comminuted to pourable powders at room temperature.

Preferred solid epoxy resins have the formula (I).

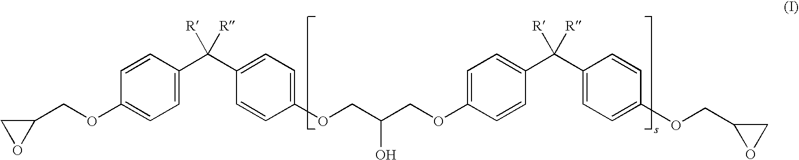

Here, the substituents R′ and R″, independently of one another, are either H or CH₃. Furthermore, the index s has a value of ≦1.5, in particular from 2 to 12.

Such solid epoxy resins are, for example, commercially available from The Dow Chemical Company, USA, from Huntsman International LLC, USA, or from Hexion Specialty Chemicals Inc., USA.

Compounds of the formula (I) having an index s of from 1 to 1.5 are referred to as semisolid epoxy resins by the person skilled in the art. For the present invention, they are likewise considered as solid resins. However, solid epoxy resins in the narrower sense, i.e. where the index s has a value of ≦1.5, are preferred.

Preferred liquid epoxy resins have the formula (II).

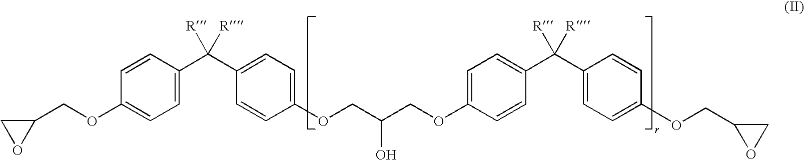

Here, the substituents R′″ and R″″, independently of one another, are either H or CH₃. Furthermore, the index r has a value of from 0 to 1. Preferably, r has a value of ≦0.2.

They are therefore preferably diglycidyl ethers of bisphenol A (DGEBA), of bisphenol F and of bisphenol A/F. The designation ‘A/F’ refers here to a mixture of acetone with formaldehyde which is used as starting material in the preparation thereof. Such liquid resins are commercially available, for example, under the trade names Araldite® GY 250, Araldite® PY 304, Araldite® GY 282 from Huntsman International LLC, USA, or D.E.R.® 331 or D.E.R.® 330 from The Dow Chemical Company, USA, or under the trade names Epikote® 828 or Epikote® 862 from Hexion Specialty Chemicals Inc., USA.

The epoxy resin A is preferably a liquid epoxy resin of the formula (II). In an even more preferred embodiment, the composition Z contains both at least one liquid epoxy resin of the formula (II) and at least one solid epoxy resin of the formula (I).

The proportion of epoxy resin A is preferably from 5 to 25% by weight, in particular from 8 to 20% by weight, preferably from 10 to 16% by weight, based on the total weight of the composition Z.

The epoxy resin A is preferably used together with at least one reactive diluent G having epoxide groups. These reactive diluents G are in particular:
Glycidyl ethers of monofunctional saturated or unsaturated, branched or straight-chain, cyclic or open-chain C₄ to C₃₀ alcohols, e.g. butanol glycidyl ether, hexanol glycidyl ether, 2-ethylhexanol glycidyl ether, allyl glycidyl ether, tetrahydrofurfuryl and furfuryl glycidyl ether, trimethoxysilyl glycidyl ether and the like.
Glycidyl ethers of difunctional saturated or unsaturated, branched or straight-chain, cyclic or open-chain C₂ to C₃₀ alcohols, e.g. ethylene glycol glycidyl ether, butanediol glycidyl ether, hexanediol glycidyl ether, octanediol glycidyl ether, cyclohexane dimethanol diglycidyl ether, neopentyl glycol diglycidyl ether and the like.
Glycidyl ethers of tri- or polyfunctional, saturated or unsaturated, branched or straight-chain, cyclic or open-chain alcohols, such as epoxidized castor oil, epoxidized trimethylolpropane, epoxidized pentaerythrol or polyglycidyl ethers of aliphatic polyols, such as sorbitol, glycerol, trimethylolpropane and the like.
Glycidyl ethers of phenol and aniline compounds, such as phenylglycidyl ether, cresyl glycidyl ether, p-tert-butylphenyl glycidyl ether, nonylphenol glycidyl ether, 3-n-pentadecenyl glycidyl ether (from cashew nut shell oil), N,N-diglycidylaniline and the like.
Epoxidized amines, such as N,N-diglycidylcyclohexylamine and the like.
Epoxidized mono- or dicarboxylic acids, such as glycidyl neodecanoate, glycidyl methacrylate, glycidyl benzoate, diglycidyl phthalate, tetrahydrophthalate and hexahydrophthalate, diglycidyl esters of dimeric fatty acids and the like.
Epoxidized di- or trifunctional, low to high molecular weight polyetherpolyols, such as polyethylene glycol diglycidyl ether, polypropylene glycol diglycidyl ether and the like.
   Hexanediol diglycidyl ether, cresyl glycidyl ether, p-tert-butylphenyl glycidyl ether, polypropylene glycol diglycidyl ether and polyethylene glycol diglycidyl ether are particularly preferred.

Advantageously, the total proportion of the reactive diluent G having epoxide groups is from 0.5 to 20% by weight, in particular from 1 to 8% by weight, based on the weight of the total composition Z.

The curing agent B has reactive groups which react with the epoxide groups of the epoxy resin A and optionally of the reactive diluent G. Such curing agents are in particular polyamines and/or polymercaptans.

Polyamines are in particular diamines or triamines, preferably aliphatic or cycloaliphatic diamines or triamines.

For example, suitable polyamines are:
aliphatic diamines, such as ethylenediamine, 1,2- and 1,3-propanediamine, 2-methyl-1,2-propanediamine, 2,2-dimethyl-1,3-propanediamine, 1,3- and 1,4-butanediamine, 1,3- and 1,5-pentanediamine, 1,6-hexanediamine, 2,2,4- and 2,4,4-trimethylhexamethylenediamine and mixtures thereof, 1,7-heptanediamine, 1,8-octanediamine, 1,9-nonanediamine, 1,10-decanediamine, 1,11-undecanediamine, 1,12-dodecanediamine, methylbis(3-aminopropyl)amine, 1,5-diamino-2-methylpentane (MPMD), 1,3-diaminopentane (DAMP), 2,5-dimethyl-1,6-hexamethylenediamine, cycloaliphatic polyamines, such as 1,3- and 1,4-diaminocyclohexane, bis(4-aminocyclohexyl)methane, bis(4-amino-3-methylcyclohexyl)methane, bis(4-amino-3-ethylcyclohexyl)methane, 2-methylpentamethylenediamine, bis(4-amino-3,5-dimethylcyclohexyl)methane, 1-amino-3-aminomethyl-3,5,5-trimethylcyclohexane (=isophoronediamine or IPDA), 2- and 4-methyl-1,3-diaminocyclohexane and mixtures thereof, 1,3- and 1,4-bis(aminomethyl)cyclohexane, 1-cyclohexylamino-3-aminopropane, 2,5(2,6)-bis(aminomethyl)bicyclo[2.2.1]heptane (NBDA, produced by Mitsui Chemicals, Inc., Japan), 3(4),8(9)-bis(aminomethyl)tricyclo-[5.2.1.0^{2,6}]decane, 1,4-diamino-2,2,6-trimethylcyclohexane (TMCDA), 3,9-bis(3-aminopropyl)-2,4,8,10-tetraoxaspiro[5.5]undecane, piperazine, 1-(2-aminoethyl)piperazine, 1,3- and 1,4-xylylenediamine; di- or polyfunctional aliphatic amines which, in addition to one or more primary amino groups, carry more than one secondary amino group, such as diethylenetriamine (DETA), triethylenetetramine (TETA), tetraethylenepentamine (TEPA), pentaethylenehexamine and higher homologs of linear polyethyleneamines, N,N′-bis(3-aminopropyl)ethylene-diamine, polyvinylamines, and polyethylenimines of different degrees of polymerization (molar mass range from 500 to 1 000 000 g/mol), as are available, for example, under the trade name Lupasol® from BASF, Germany, in pure form or as aqueous solutions, these polyethylenimines also containing tertiary amino groups in addition to primary and secondary ones;
polyamidoamines
aliphatic polyamines containing ether groups, such as bis(2-aminoethyl)ether, 4,7-dioxadecane-1,10-diamine, 4,9-dioxadodecane-1,12-diamine and higher oligomers thereof, polyoxyalkylenepolyamines having two or three amino groups, for example available under the name Jeffamine® (from Huntsman International LLC, USA), under the name polyetheramine (from BASF, Germany) or under the name PC Amine® (from Nitroil, Germany), and mixtures of the abovementioned polyamines.

Suitable triamines are sold, for example, under the Jeffamine® T line by Huntsman International LLC, USA, such as, for example, Jeffamine® T-3000, Jeffamine® T-5000 or Jeffamine® T-403.

Diamines preferred as curing agents B are in particular polyoxyalkylenepolyamines having two amino groups, corresponding to the formula (III).

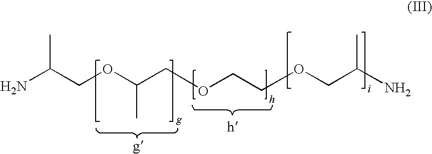

Here, g′ are the structural element which originates from propylene oxide and h′ the structural element which originates from ethylene oxide. In addition, g, h and i each have values from 0 to 40, with the proviso that the sum of g, h and i is ≦1.

In particular, molecular weights of from 200 to 5000 g/mol are preferred.

Particularly preferred are Jeffamine® as offered under the D line and ED line by Huntsman International LLC, USA, such as, for example, Jeffamine® D-230, Jeffamine® D-400, Jeffamine® D-2000, Jeffamine® D-4000, Jeffamine® ED-600, Jeffamine® ED-900, Jeffamine® ED-2003 or Jeffamine® EDR-148.

Suitable polymercaptans are, for example, polymercaptoacetates of polyols. These are in particular polymercaptoacetates of the following polyols:
polyoxyalkylenepolyols, also referred to as polyetherpolyols, which are the polymerization product of ethylene oxide, 1,2-propylene oxide, 1,2- or 2,3-butylene oxide, tetrahydrofuran or mixtures thereof, optionally polymerized with the aid of a starter molecule having two or three active H atoms, such as, for example, water or compounds having two or three OH groups. The polyoxyalkylenediols may have different degrees of unsaturation (measured according to ASTM D-2849-69 and stated in milliequivalent of unsaturation per gram of polyol (mEq/g)). Those having a low degree of unsaturation are prepared, for example, with the aid of so-called double metal cyanide complex catalysts (DMC catalysts), and those having a higher degree of unsaturation are prepared, for example, with the aid of anionic catalysts, such as NaOH, KOH, CsOH or alkali metal alcoholates. Particularly suitable are polyoxyalkylenediols or polyoxyalkylenetriols having a degree of unsaturation of ≦0.02 mEq/g and having a molecular weight in the range from 300 to 30 000 g/mol, and polyoxyethylenediols, polyoxyethylenetriols, polyoxypropylenediols and polyoxypropylenetriols having a molecular weight of from 400 to 8000 g/mol. In the present document, “molecular weight” is understood as meaning the average molecular weight Mn.
Also particularly suitable are so-called ethylene oxide-terminated (“EO-endcapped”, ethylene oxide endcapped) polyoxypropylenepolyols. The latter are specific polyoxypropylenepolyoxyethylenepolyols which are obtained, for example, by a procedure in which pure polyoxypropylenepolyols, in particular polyoxypropylenediols and -triols, are further alkoxylated with ethylene oxide after the end of the polypropoxylation reaction and thus have primary hydroxyl groups.
hydroxyl-terminated polybutadienepolyols, such as, for example, those which are prepared by polymerization of 1,3-butadiene and allyl alcohol or by oxidation of polybutadiene, and the hydrogenation products thereof;
styrene-acrylonitrile-grafted polyetherpolyols, as supplied, for example, by Elastogran GmbH, Germany, under the name Lupranol®;
polyesterpolyols, prepared, for example, from di- or trihydric alcohols, such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the abovementioned alcohols with organic dicarboxylic acids or anhydrides or esters thereof, such as, for example, succinic acid, glutaric acid, adipic acid, suberic acid, sebacic acid, dodecanedicarboxylic acid, maleic acid, fumaric acid, phthalic acid, isophthalic acid, terephthalic acid and hexahydrophthalic acid or mixtures of the abovementioned acids, and polyesterpolyols obtained from lactones, such as, for example, ε-caprolactone;
polycarbonatepolyols, as are obtainable by reacting, for example, the abovementioned alcohols, used for the synthesis of the polyesterpolyols, with dialkyl carbonates, diaryl carbonates or phosgene;
1,2-ethanediol, diethylene glycol, 1,2-propanediol, dipropylene glycol, 1,4-butanediol, 1,5-pentanediol, 1,6-hexanediol, 1,7-heptanediol, octanediol, nonanediol, decanediol, neopentyl glycol, pentaerythritol (=2,2-bishydroxymethyl-1,3-propanediol), dipentaerythritol (=3-(3-hydroxy-2,2-bishydroxymethylpropoxy)-2,2-bishydroxymethylpropan-1-ol), glycerol (=1,2,3-propanetriol), trimethylolpropane (=2-ethyl-2-(hydroxymethyl)-1,3-propanediol), trimethylolethane (=2-(hydroxymethyl)-2-methyl-1,3-propanediol, di(trimethylolpropane) (=3-(2,2-bishydroxymethylbutoxy)-2-ethyl-2-hydroxymethylpropan-1-ol), di(trimethylolethane) (=3-(3-hydroxy-2-hydroxymethyl-2-methylpropoxy)-2-hydroxymethyl-2-methylpropan-1-ol), diglycerol (=bis(2,3-dihydroxypropyl)ether);
polyols as are contained by reduction of dimerized fatty acids.

Glycol dimercaptoacetate, trimethylolpropane trimercaptoacetate and butanediol dimercaptoacetate are particularly preferred.

Preferred polymercaptans are in particular dimercaptans. Preferred dimercaptans are in general those of the formula (IV).

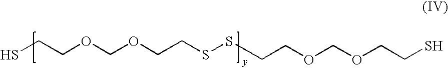

Here, y has a value of from 1 to 45, in particular from 5 to 23. The preferred molecular weights are from 800 to 7500 g/mol, in particular from 1000 to 4000 g/mol.

Such polymercaptans are commercially available under the Thiokol® LP series from Toray Fine Chemicals Co., Ltd., Japan.

Adducts of polyamines and/or polymercaptans, in particular of the abovementioned polyamines and/or polymercaptans, with epoxides, in particular with the abovementioned epoxy resins A and/or the reactive diluents G, can also serve as curing agents B.

The amount of the curing agent B may be such that its groups reactive with epoxide groups are present in a substoichiometric or superstoichiometric amount relative to the epoxide groups of the epoxy resin A and optionally those of the reactive diluent G. The amount of the curing agent B is preferably such that the groups of the curing agent B which are reactive with epoxide groups undergo a stoichiometric reaction in the composition Z with the epoxide groups of the epoxy resin A and optionally of the reactive diluent G.

The zinc particles in the composition Z are selected in particular from the group consisting of zinc dust, zinc powder, zinc chips, zinc lamellae, zinc grit, zinc granules and the like. Zinc particles are in particular zinc lamellae, often also referred to as “zinc flakes”.

The zinc particles preferably have an average particle size of from 0.5 to 500 μm, in particular from 1 to 50 μm, preferably from 10 to 20 μm.

The proportion of zinc particles is preferably from 55 to 90% by weight, in particular from 60 to 85% by weight, preferably from 65 to 80% by weight, based on the total composition Z.

Here, the term “zinc particles” is also understood as meaning alloys of zinc which are present as particles. The zinc is present in such alloys with at least one further metal which has a more negative standard potential than the iron of the reinforcing steel. In particular, these alloy constituents of zinc are aluminum and/or magnesium, it being clear to the person skilled in the art that the choice of the alloy constituents must be tailored to the conditions, such as, for example, the pH, in the reinforced concrete.

Mixtures of zinc particles with particles of at least one further metal which has a more negative standard potential than the iron of the reinforcing steel are also preferred. These metal particles are in particular aluminum and/or magnesium particles. It is clear to the person skilled in the art that the choice of the metals used must be tailored to the conditions, such as, for example, the pH, in the reinforced concrete.

Particularly suitable are mixtures of zinc particles and aluminum particles, the proportion of the aluminum particles being from 1 to 50% by weight, in particular from 10 to 50% by weight, preferably from 20 to 40% by weight, based on the total composition Z.

The aluminum particles are present in particular in the form of aluminum dust, aluminum powder, aluminum chips, aluminum lamellae, aluminum grit, aluminum granules and the like.

Preferably, the aluminum particles have an average particle size of from 1 to 1000 μm, in particular from 1 to 500 μm, preferably from 5 to 400 μm.

Furthermore, the composition Z may additionally have a metal halide. This is in particular a halide of an alkali metal, preferably lithium. Metal halide is most preferably lithium chloride.

The proportion of the metal halide is preferably from 0.1 to 20% by weight, in particular from 1 to 15% by weight, preferably from 1 to 10% by weight, based on the total composition Z.

Accordingly, a further aspect of the invention also relates to a composition Z comprising at least one epoxy resin A; at least one curing agent B for epoxy resins; zinc particles; and a metal halide, in particular a lithium halide, preferably lithium chloride.

Surprisingly, it has been found that the addition of a metal halide, in particular lithium chloride, improves the efficiency of the composition Z as cathodic corrosion protection. This is due in particular to the hygroscopic properties of the metal halide, with the result that the moisture transport to and within the anode is accelerated.

Preferably, the composition Z is present as a two-component or as a three-component composition.

If the composition Z is present as a three-component composition, the first component K1 comprises at least one epoxy resin A, the second component K2 comprises at least one curing agent B and the third component K3 comprises at least the zinc particles.

If the composition Z is present as a two-component composition, the zinc particles are present either in a first component K1′ together with the epoxy resin A or in a second component K2′ together with the curing agent B or in both components K1′ and K2′.

The components K1, K2 and K3 or K1′ and K2′, independently of one another, may have further constituents which in particular are selected from the group consisting of catalysts, heat stabilizers and/or light stabilizers, thixotropic agents, plasticizers, solvents, wetting agents, in particular pigment wetting agents, mineral or organic fillers, inhibitors, antifoams, deaerators, antisettling agents, rheology modifiers, blowing agents, dyes and pigments. It is of course clear to the person skilled in the art that no constituents which react with one another and thus might have adverse effects on the shelf-life of the composition Z are mixed within a component.

For the use of the composition Z as cathodic corrosion protection for reinforcements of reinforced concrete structures, the composition Z preferably has a deformable, pasty consistency prior to curing, said composition curing in the course of time by the reaction of the epoxy resin A and optionally of the reactive diluent G with the curing agent B.

The composition Z is applied at certain points to at least one point on the reinforcing steel.

The average layer thickness in which the composition Z is applied at certain points to the reinforcing steel is preferably from 0.5 to 8 cm, in particular from 0.75 to 6 cm, preferably from 1 to 4 cm.

The mass of in each case one of these applications applied at certain points is on average preferably from 100 to 500 g, in particular from 150 to 400 g, preferably from 200 to 300 g.

Typically, the application at certain points is effected at a plurality of points to the reinforcing steel, preferably at a distance of from 30 to 200 cm, in particular from 40 to 150 cm, preferably from 50 to 120 cm, relative to one another.

In particular, the invention relates to the use of the composition Z as described above as cathodic corrosion protection for reinforcements of reinforced concrete structures, comprising the steps:

i) mixing of components K1, K2 and K3 or K1′ and K2′;
ii) application of the composition Z to the reinforcing steel;
iii) curing of the composition Z.

The application of the composition Z is typically effected manually, with a trowel, spatula or the like or directly from a packaging, such as, for example, a cartridge, onto the exposed, preferably degreased and derusted reinforcing steel. Owing to the consistency of the composition Z, no additional fastening means, such as wires and the like, are required for the application. The composition adheres directly to the reinforcing steel, but also to the surrounding concrete or to the surrounding mortar.

The curing of the composition Z takes place by the reaction of the epoxide groups of the epoxy resin A and optionally of the reactive diluent G with the reactive groups of the curing agent B.

The reinforcing steel to which the composition Z was applied can be encased in concrete or covered with repair mortar after or even during the curing reaction of the epoxy resin A with the curing agent B. Preferably, the curing of the composition Z takes place during about 24 hours before the encasing in concrete or before the covering with repair mortar.

The repair mortar with which a break or repair area is covered adheres to the concrete, to the steel and to the composition Z. This type of mutual bonding results in a sort of monolithic structure, giving rise to a non-positively bonded construction which has no weak points in the region of the corrosion protection system.

Furthermore, the invention comprises a laminate body consisting of reinforcing steel, concrete and/or mortar or repair mortar and a layer which was obtained by the curing reaction of a composition Z as described above.

### BRIEF DESCRIPTION OF THE DRAWINGS

Below, working examples of the invention are illustrated in more detail with reference to the drawings. Identical elements or elements having the same effect are provided with the same reference numerals in the various figures. Of course, the invention is not limited to working examples shown and described.

FIG. 1 shows a schematic diagram of reinforcing steel with composition Z applied at certain points;

FIG. 2 shows a schematic diagram of a cross section through a composition Z applied to reinforcing steel at certain points or a cross section through the line A-A in FIG. 1;

FIG. 3 shows a schematic diagram of a break or repair area on a reinforced concrete structure;

FIG. 4 shows a schematic diagram of a cross section through a break or repair area on a reinforced concrete structure;

FIG. 5 shows a schematic diagram of a laminate body comprising a layer of reinforcing steel, a layer of the composition Z, which may have at least partly cured, and a layer of mortar;

FIG. 6 shows a schematic diagram of a laminate body comprising a layer of concrete, a layer of reinforcing steel, a layer of the composition Z, which may have at least partly cured, and a layer of mortar.

Only the elements essential for the direct understanding of the invention are shown in the figures.

### DESCRIPTION OF PREFERRED EMBODIMENTS

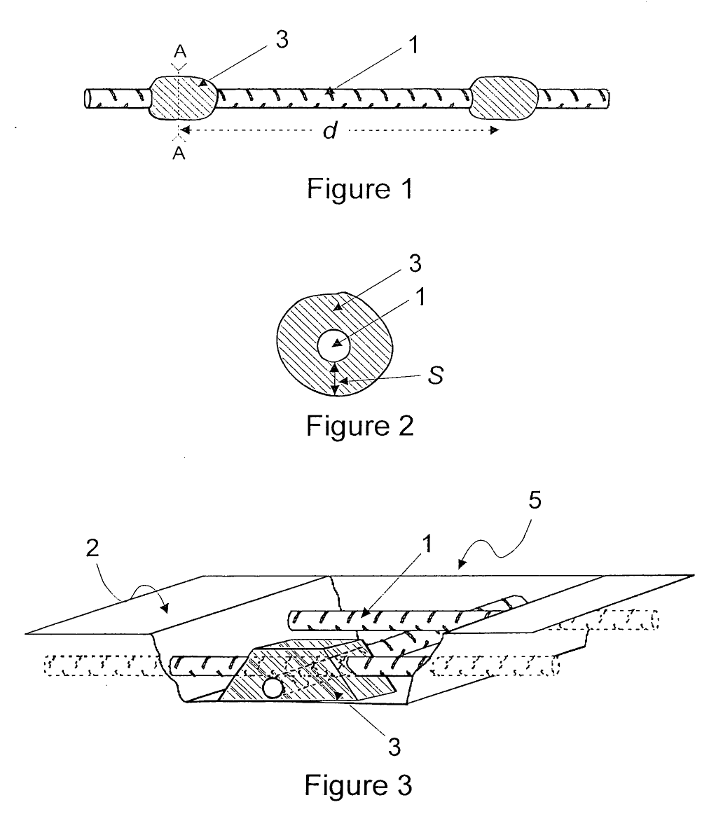

FIG. 1 shows, in a schematic diagram, composition Z 3 applied at certain points to the reinforcing steel 1, as applied manually, for example, to exposed reinforcing steel not yet encased in concrete. Typically, the applied composition Z 3 has the form of a lump. In order to achieve an optimum corrosion protection performance, the composition Z 3 is applied to a plurality of points on the reinforcing steel. The application of the composition Z 3 at certain points is preferably effected at a distance d of from 30 to 200 cm, in particular from 40 to 150 cm, preferably from 50 to 120 cm, relative to one another.

FIG. 2 shows, in a schematic diagram, a cross section through a composition Z 3 applied at certain points on the reinforcing steel 1, along the line A-A in FIG. 1. The average layer thickness S of the applied composition is preferably from 0.5 to 8 cm, in particular from 0.75 to 6 cm, preferably from 1 to 4 cm.

FIG. 3 shows a schematic perspective diagram of a reinforced concrete structure 2 having a break or repair area 5 in which a composition Z 3 has been applied at certain points on the reinforcing steel 1. In this way, the composition Z is used in particular in repair of reinforced concrete structures.

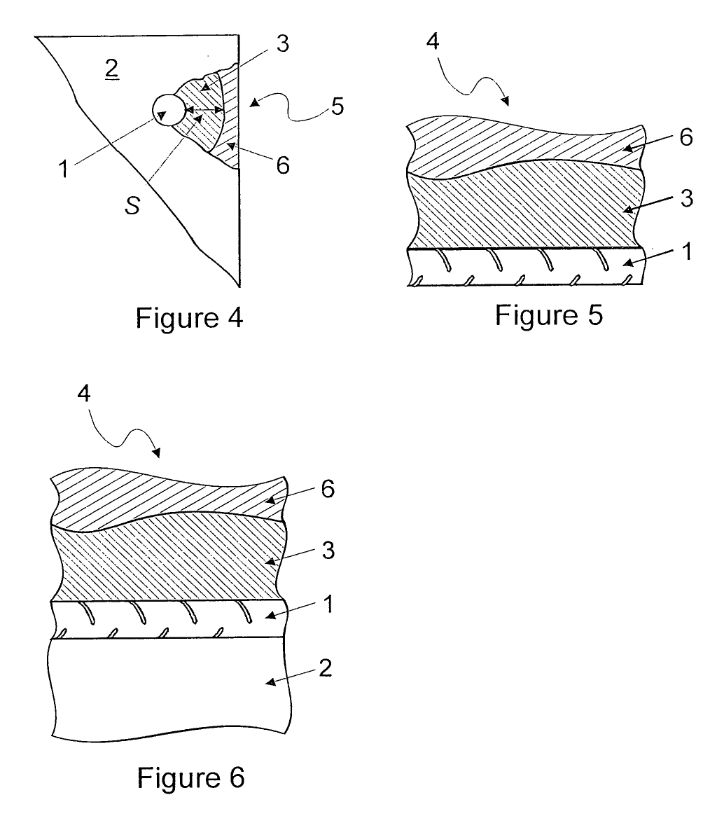

FIG. 4 shows, in a schematic diagram, a cross section through a break or repair area 5 in which a composition Z 3 was applied to the reinforcing steel 1. The break or repair area 5 is covered with a repair mortar 6 after the application of the composition Z 3.

The potential uses of the composition Z for repairs of reinforced concrete structures, as shown in FIGS. 3 and 4, prove to be particularly advantageous because the reinforcing steel 1 may be exposed only in a few selected areas in order to renew the corrosion protection of an existing reinforced concrete structure. It is furthermore advantageous that the reinforcing steel in a break or repair area 5 may not be exposed over a large area and completely, i.e. all around. The space requirement is small and access to the reinforcing steel from one side is sufficient for applying the composition Z since it need not be fastened with wires or other fastening means to the reinforcing steel but can simply be stuck on the reinforcing steel without the use of an adhesive. Likewise, the application on one side gives rise to a contact area between the composition Z and the reinforcing steel which is sufficient for the corrosion protection. As a result of the sticking of the composition Z to the steel and to the reinforced concrete and the good adhesion of the repair mortar on the steel, on the reinforced concrete and on the composition Z or on the cured composition Z, no weak points arise within the reinforced concrete structure at the break or repair area 5 but instead a non-positive bond.

FIG. 5 and FIG. 6 each show a laminate body 4 consisting of reinforcing steel 1, the composition Z 3, which may have cured, and concrete 2, and/or mortar or repair mortar 6.

### Examples

### Preparation of the Composition Z1

The following composition Z1 was prepared:

As component K1 the component A and as component K2 the component B of the commercially available product Sikafloor®-156 from Sika Deutschland GmbH were used. The components K1 and K2 were mixed with one another in a weight ratio K1:K2 of 3:1 with the aid of a mixing apparatus.

Zinc grit having a particle size of <45 μm, which is commercially available under the name ZG777 from Eckart Switzerland SA, was used as component K3. The component K3 was used in a weight ratio K3:(K1+K2) of 2.5:1 and mixed with the aid of a mixing apparatus.

### Preparation of the Test Mortar

The following mortar mix was prepared:

| | |
|---|---|
| Cement CEM I 42.5 | 8.4 kg |
| Limestone filler | 3 kg |
| Sand 0 to 1 mm | 22 kg |
| Sand 1 to 4 mm | 25 kg |

The cement, the filler and the sands were dry mixed in a mixer. The mixing water, in which 6.6% by weight of sodium chloride (NaCl), based on the total amount of water, is dissolved, is then added. The water/cement value has a value of 0.75.

### Description of the Tests

In each case two reinforcing steel bars were embedded in a block of test mortar. One of the reinforcing steel bars was provided with a corrosion protection system and the second was present in unprotected form for comparison reasons.

The samples were stored for 13 months under humid conditions at a temperature of 20° C. and a relative humidity of 95% and then opened for assessing corrosion. The rating of the corrosion was based on a visual analysis, the individual samples being compared with one another.

The rating scale specified was:
−1: steel with corrosion protection system shows more corrosion than steel without corrosion protection system;
0: no difference between the two steel samples;
1: from 50 to 75% corrosion on the steel with corrosion protection system in comparison with the steel without corrosion protection system;
2: from 20 to 50% corrosion on the steel with corrosion protection system in comparison with the steel without corrosion protection system;
3: no visible corrosion on the steel with corrosion protection system

Corrosion protection systems tested were the composition Z1 and the commercially available products Galvashield® XP and Galvashield® XP+ from Vector Corrosion Technologies Ltd., Canada.

### Results

| | |
|---|---|
| Composition Z1 | 2 |
| Galvashield ® XP | −1 |
| Galvashield ® XP+ | 1 |

The results show that the composition Z1 or the cured composition Z1 has a better corrosion protection performance compared with reference examples. The reference example Galvashield® XP+ shows a respectable corrosion protection performance but, like the reference example Galvashield® XP, it has disadvantages in the complicated mounting. The reference example Galvashield® XP has an insufficient corrosion protection performance under the test conditions.

### LIST OF REFERENCE NUMERALS

1 Reinforcement/reinforcing steel
2 Reinforced concrete structure/concrete
3 Composition Z applied at certain points or cured composition Z
4 Laminate body
5 Break or repair area
6 Mortar/repair mortar
d Distance
S Layer thickness

1. A method of protecting reinforcing steel of reinforced concrete structures from cathodic corrosion, comprising:
applying a composition Z to reinforcing steel, the composition Z comprising:
a) at least one epoxy resin A;
b) at least one curing agent B for epoxy resins; and
c) zinc particles.

2. The method of claim 1,
wherein
the composition Z has a pasty consistency.

3. The method of claim 1, wherein
the proportion of the epoxy resin A is from 5 to 25% by weight; and
the proportion of the zinc particles is from 55 to 90% by weight;
based on the total weight of the composition Z.

4. The method of claim 1, wherein
the zinc particles are selected from the group consisting of zinc dust, zinc powder, zinc chips, zinc lamellae, zinc grit, zinc granules and the like.

5. The method of claim 1, wherein
the zinc particles have an average particle size of from 0.5 to 500 μm.

6. The method of claim 1, wherein
the composition Z is applied to the reinforcing steel at certain points.

7. The method of claim 1, wherein
the composition Z is applied at certain points and in an average layer thickness (S) of from 0.5 to 8 cm to the reinforcing steel.

8. The method of claim 6, wherein
in each case from 100 to 500 g of the composition Z are applied at certain points to the reinforcing steel.

9. The method of claim 6, wherein
the composition Z is applied at certain points in a plurality of areas at a distance (d) of from 30 to 200 cm to the reinforcing steel.

10. The method of claim 6, wherein
the composition Z is present as a two- or three-component composition.

11. The method of claim 1, wherein
the composition Z is present as a three-component composition, the first component K1 comprising the epoxy resin A; the second component K2 comprising the curing agent B; and the third component K3 comprising the zinc particles.

12. The method of claim 1, wherein
the composition Z is present as a two-component composition, the zinc particles
either being present in a first component K1′ together with the epoxy resin A;
or being present in a second component K2′ together with the curing agent B;
or being present in both components K1′ and K2′.

13. The method of claim 11, further comprising the steps
i) mixing the components K1, K2 and K3 before applying the composition Z to the reinforcing steel; and
ii) curing of the composition Z.

14. A laminate body consisting of reinforcing steel, concrete and/or mortar and a layer which was obtained by the curing reaction of a composition Z,
wherein
the composition Z, prior to curing, comprises
a) at least one epoxy resin A;
b) at least one curing agent B for epoxy resins; and
c) zinc particles;
and is present at least partially between a layer of reinforcing steel and a layer of concrete or mortar.

15. The laminate body as claimed in claim 14,
wherein
the layer which was obtained by the curing reaction of a composition Z has an average layer thickness (S) of from 0.5 to 8 cm.

16. The laminate body as claimed in claim 14,
wherein
the proportion of the epoxy resin A prior to the curing reaction is from 5 to 25% by weight and
the proportion of the zinc particles is from 55 to 85% by weight;
based on the total weight of the composition Z.

17. A composition Z comprising at least one epoxy resin A; at least one curing agent B for epoxy resins; zinc particles; and a metal halide.
